(19) United States
(12) Patent Application Publication
(10) Pub. No.: US 2013/0239920 A1
(43) Pub. Date: Sep. 19, 2013

(54) ROTARY ENERGY TRANSDUCER

(71) Applicant: Lawrence McMillan, Tulsa, OK (US)

(72) Inventor: Lawrence McMillan, Tulsa, OK (US)

(21) Appl. No.: 13/488,998

(22) Filed: Jun. 5, 2012

Related U.S. Application Data
(63) Continuation-in-part of application No. 13/463,360, filed on May 3, 2012.
(60) Provisional application No. 61/518,514, filed on May 6, 2011.

(51) Int. Cl. F02B 43/12; F02B 43/10; F02B 1/06

(52) U.S. Cl. 123/1 A; 123/294

(57) ABSTRACT

An energy transducer comprising: a body; a crankshaft; a rotor mounted to the crankshaft and housed within the body such that the rotor may rotate within the body along an axis defined by the crankshaft; one or more chambers located circumferentially around the rotor and angled inward toward the direction of travel of the rotor; an injector connected to the body such that the injector injects fuel into the one or more chambers; and an igniter connected to the body such that the igniter ignites the fuel in the one or more chambers, which causes the rotor to rotate. The fuel may be hydrogen or a mixture of hydrogen and oxygen.

### CROSS REFERENCE

This application is a continuation in part application based on and claiming priority to U.S. patent application Ser. No. 13/463,360 filed May 3, 2012, which was based on provisional U.S. patent application No. 61/518,514 filed May 6, 2011.

### BACKGROUND OF THE INVENTION

1. Field of the Invention

This invention relates generally to an energy transducer, and more particularly, but not by way of limitation, to a hydrogen powered rotary energy transducer.

2. Description of the Related Art

Internal combustion engines, such as those used in automobiles, typically run on gasoline or other fossil fuel. Such an engine consumes 75% of the energy it produces to perform its task, leaving only 25% of the energy for usable power.

It is desirable to provide an energy transducer that does not depend on fossil fuel.

It is further desirable for such an energy transducer to run on hydrogen.

It is further desirable for such an energy transducer to allow for greater utilization of the energy it creates.

### SUMMARY OF THE INVENTION

In general, in a first aspect, the invention relates to an energy transducer comprising: a body; a crankshaft; a rotor mounted to the crankshaft and housed within the body such that the rotor may rotate within the body along an axis defined by the crankshaft; one or more chambers located circumferentially around the rotor; an injector connected to the body such that the injector injects fuel into the one or more chambers; and an igniter connected to the body such that the igniter ignites the fuel in the one or more chambers, which causes the rotor to rotate. The fuel may be hydrogen or a mixture of hydrogen and oxygen. The one or more chambers may be each angled inward toward the direction of travel of the rotor.

The energy transducer may further comprise a hydrogen control valve connected to the injector to control the amount of fuel injected into the one or more chambers. The igniter and the hydrogen control valve may be controlled by an electronic controller, which may be controlled by a throttle.

The energy transducer may further comprising multiple bodies and a common crankshaft, each body with: a rotor mounted to the crankshaft and housed within the body such that the rotor may rotate within the body along an axis defined by the crankshaft; one or more chambers located circumferentially around the rotor; an injector connected to the body such that the injector injects fuel into the one or more chambers; and an igniter connected to the body such that the igniter ignites the fuel in the one or more chambers, which causes the rotor to rotate.

The igniter may be located adjacent the injector, but further along a path of rotation of the rotor. The energy transducer may further comprising an exhaust port located within the body such that the exhaust port is capable of venting exhaust from the one or more chambers, and the exhaust port may be located adjacent the injector, but prior to the injector along a path of rotation of the rotor.

A method of transducing energy using the energy transducer may comprise: providing a body, a crankshaft, a rotor mounted to the crankshaft and housed within the body such that the rotor may rotate within the body along an axis defined by the crankshaft, and one or more chambers located circumferentially around the rotor; injecting fuel into one of the chambers via an injector connected to the body; igniting the fuel in the chamber with an igniter, causing an explosion; and allowing the explosion to force the rotor and crankshaft to rotate. The fuel may be hydrogen or a mixture of hydrogen and oxygen.

The method may further comprise controlling the amount of fuel injected into the one or more chambers with a hydrogen control valve, and controlling the igniter and the hydrogen control valve with an electronic controller. The method may further comprise controlling the electronic controller via a throttle.

The method may further comprise venting exhaust from the chamber via an exhaust port. Finally, the method may further comprise repeating said injecting, igniting, and allowing steps cyclically for each of the one or more chambers.

### BRIEF DESCRIPTION OF THE DRAWINGS

FIG. 1 is diagrammatic view of the energy transducer described herein;

FIG. 2 is a diagrammatic view of the energy transducer at the beginning of a cycle;

FIG. 3 is a diagrammatic view of the energy transducer partway through a cycle; and

FIG. 4 is a side diagrammatic view of the energy transducer.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

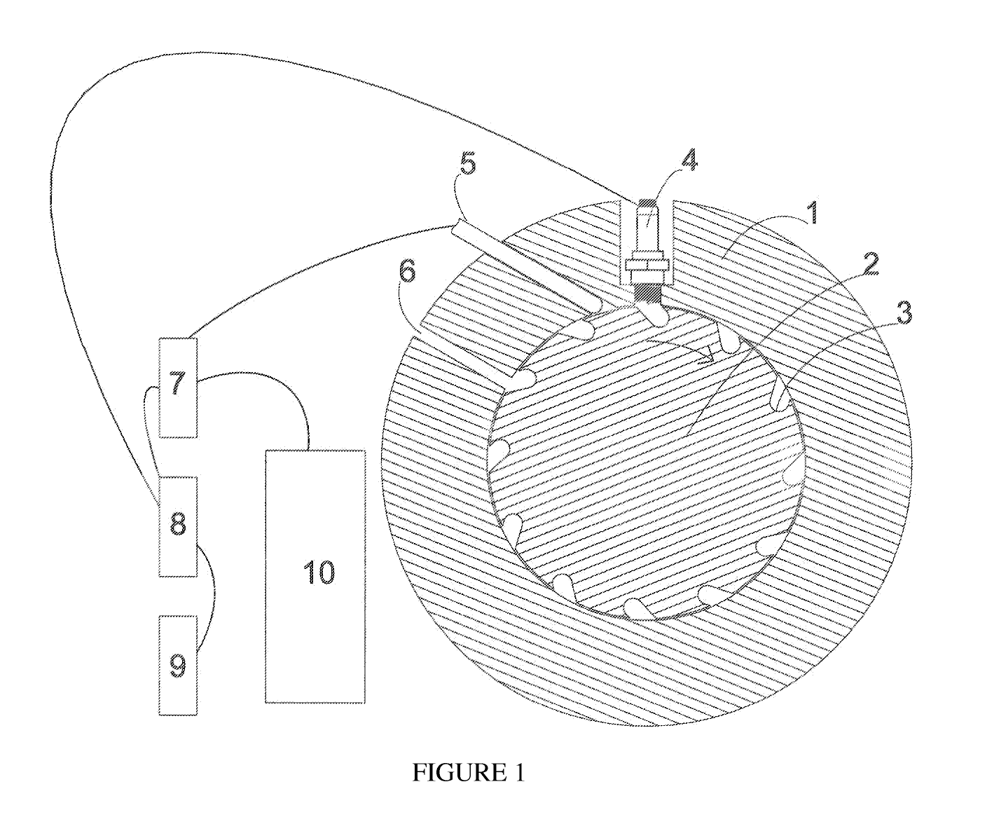

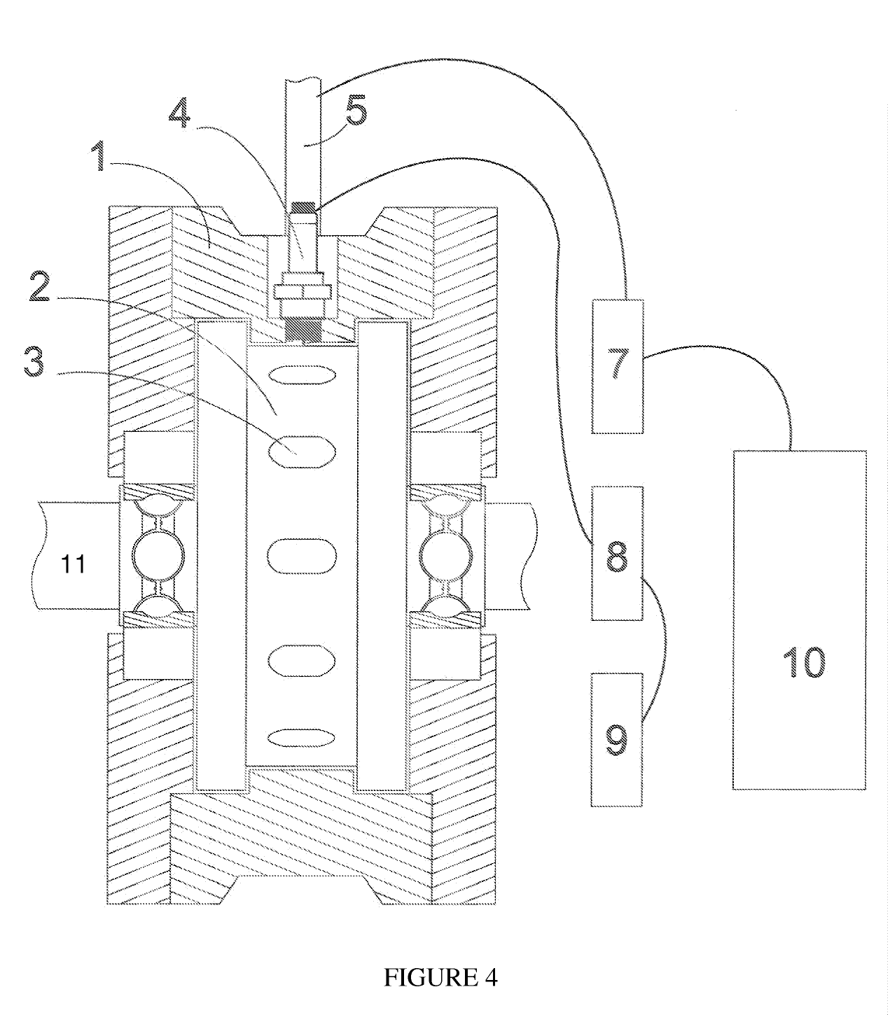

In general, in a first aspect, the invention relates to a hydrogen powered rotary energy transducer. The energy transducer utilizes hydrogen rather than fossil fuels, capturing the energy within the hydrogen. As used herein, hydrogen may refer to a mixture of hydrogen and oxygen. In the present invention, the energy from the hydrogen is converted to power by a pump, such as a piston pump, rotary pump, thrust pump, or gear pump. The energy transducer may utilize a single pump or multiple pumps in any configuration. FIGS. 1 through 4 show a single rotary pump, comprising a body 1, a rotor 2, and a crankshaft 11.

The energy transducer may comprise a body 1 housing the rotor 2 such that the rotor 2 may freely rotate within the body 1 along an axis defined by the crankshaft 11. One or more chambers 3 may be located circumferentially around the rotor 2. The chambers 3 may be angled inward toward the direction of travel of the rotor 2, as seen in FIGS. 1 through 3. A direct injector 5 may be connected to the body 1 such that the direct injector 5 may inject hydrogen into the chambers 3 one at a time as the rotor 2 rotates. A hydrogen control valve 7 may be connected to the direct injector 5 to control the amount of hydrogen injected into the chambers 3. A hydrogen storage tank 10 may be in fluid communication with the direct injector 5 via the hydrogen control valve 7.

An igniter 4, such as a spark plug, may likewise be connected to the body 1 such that the igniter 4 may ignite the hydrogen within the chamber 3. The igniter 4 may be located near the injector 5, but further along the path of rotation of the rotor 2. The igniter 4 may be out of phase with the injector 5, such that when a chamber 3 is aligned with the igniter 4, there is not a chamber 3 aligned with the injector 5; likewise, when a chamber 3 is aligned with the injector 5, there is not a chamber 3 aligned with the igniter 4. An exhaust port 6 may also be located within the body I such that it may vent exhaust from the chambers 3 after ignition. The exhaust port 6 may be located near the injector 5, but before the injector 5 along the path of rotation of the rotor 2. The exhaust port 6 may also be out of phase with the injector 5, such that when a chamber 3 is aligned with the exhaust port 6, there is not a chamber 3 aligned with the injector 5, and when a chamber 3 is aligned with the injector 5, there is not a chamber 3 aligned with the exhaust port 6. An electronic controller 8 may be connected to the igniter 4 and the hydrogen control valve 7, thus controlling the overall function of the transducer. The electronic controller 8 may be connected to a throttle 9, such that an operator of a vehicle utilizing the transducer may control the transducer via the throttle 9.

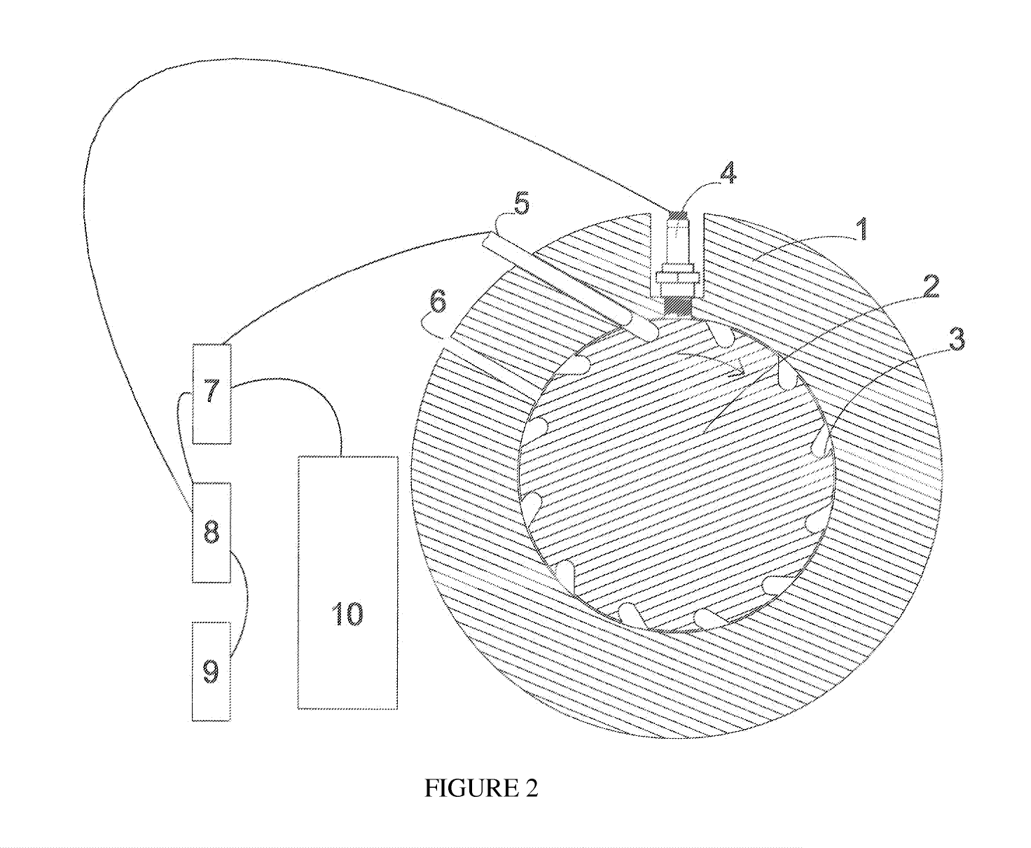

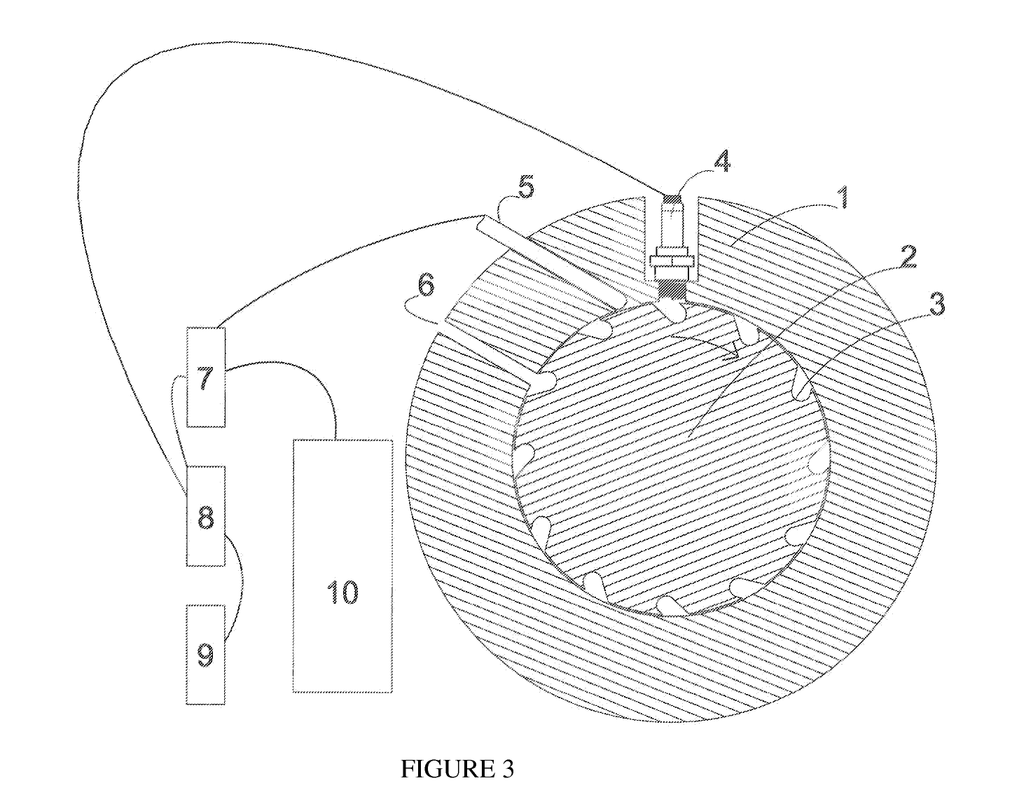

In use, the rotor 2 begins with a chamber 3 aligned with the injector 5. The injector 5 injects hydrogen into one of the chambers 3. The rotor 2 rotates such that the chamber 3 bearing hydrogen is aligned with the igniter 4. The igniter 4 fires, causing the hydrogen in the chamber 3 to explode. This explosion forces the rotor 2 to rotate, which in turn causes the crankshaft 11 to rotate. This movement may be seen in FIGS. 2 and 3. When the chamber 3 in which the explosion occurred reaches the exhaust port 6, exhaust is removed from the chamber 3. The process is repeated cyclically for each of the chambers 3.

The energy/RPMs of the energy transducer may be controlled by the timing and/or size of the explosion of the hydrogen. The size of the chambers 3 is not important; the size of the rotor 2 controls the amount of power it makes.

Whereas, the devices and methods have been described in relation to the drawings and claims, it should be understood that other and further modifications, apart from those shown or suggested herein, may be made within the spirit and scope of this invention.

What is claimed is:

1. An energy transducer comprising:
a body;
a crankshaft;
a rotor mounted to the crankshaft and housed within the body such that the rotor may rotate within the body along an axis defined by the crankshaft;
one or more chambers located circumferentially around the rotor;
an injector connected to the body such that the injector injects fuel into the one or more chambers; and
an igniter connected to the body such that the igniter ignites the fuel in the one or more chambers, which causes the rotor to rotate.

2. The energy transducer of claim 1 where the fuel is hydrogen or a mixture of hydrogen and oxygen.

3. The energy transducer of claim 1 where the one or more chambers are each angled inward toward a direction of travel of the rotor.

4. The energy transducer of claim 1 further comprising a hydrogen control valve connected to the injector to control the amount of fuel injected into the one or more chambers.

5. The energy transducer of claim 4 where the igniter and the hydrogen control valve are controlled by an electronic controller.

6. The energy transducer of claim 5 where the electronic controller is controlled by a throttle.

7. The energy transducer of claim 1 further comprising multiple bodies and a common crankshaft, each body with:
a rotor mounted to the crankshaft and housed within the body such that the rotor may rotate within the body along an axis defined by the crankshaft;
one or more chambers located circumferentially around the rotor;
an injector connected to the body such that the injector injects fuel into the one or more chambers; and
an igniter connected to the body such that the igniter ignites the fuel in the one or more chambers, which causes the rotor to rotate.

8. The energy transducer of claim 1 where the igniter is located adjacent the injector, but further along a path of rotation of the rotor,

9. The energy transducer of claim 1 further comprising an exhaust port located within the body such that the exhaust port is capable of venting exhaust from the one or more chambers.

10. The energy transducer of claim 9 where the exhaust port is located adjacent the injector, but prior to the injector along a path of rotation of the rotor.

11. A method of transducing energy, the method comprising:
providing:
a body;
a crankshaft;
a rotor mounted to the crankshaft and housed within the body such that the rotor may rotate within the body along an axis defined by the crankshaft; and
one or more chambers located circumferentially around the rotor;
injecting fuel into one of the chambers via an injector connected to the body;
igniting the fuel in the chamber with an igniter, causing an explosion; and
allowing the explosion to force the rotor and crankshaft to rotate.

12. The method of claim 11 where the fuel is hydrogen or a mixture of hydrogen and oxygen.

13. The method of claim 11 where the method further comprises controlling amount of fuel injected into the one or more chambers with a hydrogen control valve.

14. The method of claim 13 further comprising controlling the igniter and the hydrogen control valve with an electronic controller.

15. The method of claim 14 further comprising controlling the electronic controller via a throttle.

16. The method of claim 11 further comprising venting exhaust from the chamber via an exhaust port.

17. The method of Claim 11 further comprising repeating said injecting, igniting. and allowing steps cyclically for each of the one or more chambers.
